(19) United States
(12) Patent Application Publication
(10) Pub. No.: US 2008/0095155 A1
(43) Pub. Date: Apr. 24, 2008

(54) Programmable communications system

(75) Inventor: Joel I. Danzig, Alpharetta, GA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/898,886

(22) Filed: Sep. 17, 2007

Related U.S. Application Data
(60) Provisional application No. 60/853,763, filed on Oct. 24, 2006.

(51) Int. Cl. H04L 12/56; H04J 3/16; H04J 3/22

(52) U.S. Cl. 370/389; 370/467

(57) ABSTRACT

An downstream external Physical Layer (PHY) interface between a network and an edge quadrature amplitude modulator (EQAM) is provided. The interface comprises, an input direct memory access (DMA) controller enabled to control rate of packets received from the network, a plurality of buffers to store received packets, a first module enabled to convert packets to a first format and a second module enabled to convert packets to a second format. The interface further comprises a plurality of processors enabled to customize an output format of packets based on instructions stored in an instruction memory and a plurality of flow meters enabled to determine an output rate for packets based on, at least in part, a modulator rate of the EQAM. An output DMA controller controls the rate of egress of packets to the EQAM.

### CROSS-REFERENCE TO RELATED APPLICATIONS

This application claims the benefit of U.S. Provisional Application No. 60/853,763 filed Oct. 24, 2006, which is incorporated herein by reference in its entirety.

### BACKGROUND OF THE INVENTION

1. Field of the Invention

The present invention generally relates to communications processors.

2. Background Art

Data Over Cable Service Interface Specification (DOCSIS) is a standard for cable modem interfaces. DOCSIS defines the communications and operation support interface requirements for data over cable systems. It permits the addition of high-speed data transfer to an existing cable TV (CATV) system. It is employed by many cable television providers to provide Internet access over networks such as Hybrid Fiber Coaxial (HFC) networks.

The Modular Cable Modem Termination System (M-CMTS™) specification defines the requirements for head-end components in a DOCSIS system. The Downstream External Physical layer Interface (DEPI) specification describes protocol requirements for the transport of downstream user data between the M-CMTS Core and an Edge Quadrature Amplitude Modulator (EQAM). Conventional processors implementing the DEPI protocol are limited in configurability and do not support EQAM line rate for multiple channels having multiple priority levels. Methods and systems are needed for to overcome the above mentioned deficiencies.

### BRIEF SUMMARY OF THE INVENTION

Methods and systems for a downstream external physical layer interface between a network and an edge quadrature amplitude modulator (EQAM) are provided. The system according to an embodiment of the invention comprises an input processor enabled to receive Ethernet packets from the network, format the Ethernet packets into a DOCSIS format and convert the DOCSIS formatted packets into one of a Moving Picture Experts Group Transport Stream (MPT) format or a Packet Streaming Protocol (PSP) format. The system further comprises a buffer pool coupled to the input processor and partitioned to store the MPT or PSP formatted packets according to channel and priority level per channel. The system includes a plurality of output processors coupled to the buffer pool and enabled to format the MPT or PSP packets in a Layer 2 Tunneling Protocol Version 3 (L2TPV3) format and output the L2TPV3 packets at an edge quadrature amplifier modulator line rate.

The method, according to an embodiment of the invention, of providing a downstream interface between the network and the EQAM comprises receiving packets from the network, formatting the received packets into a first format and buffering the formatted packets. The buffered packets are formatted in a second format and the packets are transmitted in the second format to the EQAM at a rate based on a modulator rate of the EQAM. In an embodiment, the first format is one of a MPT format or a PSP format and the second format is a L2TPV3 format.

It is to be appreciated that even though embodiments are described with reference to a DOCSIS system, it may be applied to any communication protocol where packets from multiple channels and multiple priorities per channel are to be processed with a high bandwidth protocol engine followed by formatting into packets by a programmable header generator or protocol encapsulation engine.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an example communications system according to an embodiment of the invention.

FIG. 2 is an example embodiment of a Downstream External PHY Interface (DEPI) core according to an embodiment of the invention.

FIG. 3A illustrates a flowchart showing steps performed by an input processor according to an embodiment of the present invention.

FIG. 3B illustrates a flowchart showing steps performed by output processors according to an embodiment of the present invention.

FIG. 4 is a block diagram of a computer system on which the present invention can be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

TABLE OF CONTENTS

```
1. Overview
2. Example DOCSIS system architecture
3. DEPI core architecture
    3a. Input Processor
    3b. Buffer Pool
    3c. Output Processors
4. Example Methods
5. Example General Purpose Computer System
6. Conclusion
```

### 1. OVERVIEW

The present invention provides apparatus and methods for the transport of downstream user data between the M-CMTS Core and an Edge Quadrature Amplitude Modulator (EQAM) in a DOCSIS system. Embodiments of the invention provide configurable packet flow control, support for multiple channels with each channel having multiple levels of priority, customized formatting of packets on a per-channel basis, support for packet egress at EQAM line rates, firmware upgradeability, multiple processors with associated instruction and data memory and concatenation or fragmentation of packets. It is to be appreciated that even though embodiments are described with reference to a DOCSIS system, embodiments may be applied to any communication protocol where packets from multiple channels and multiple priorities per channel are to be processed with a high bandwidth protocol engine followed by formatting into packets by a programmable header generator or protocol encapsulation engine.

In the detailed description of the invention that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### 2. EXAMPLE DOCSIS SYSTEM ARCHITECTURE

A DOCSIS communications system includes two primary components: a Cable Modem (CM) located at the customer premises, and a Modular Cable Modem Termination System (M-CMTS) located at the CATV headend.

A typical modular cable modem termination system hosts downstream and upstream ports. For duplex communication between a modular cable modem termination system and a cable modem two physical ports are used unlike Ethernet, where one port provides duplex communications. Because of the noise in the return (upstream) path, there are more upstream ports than downstream ports such that the additional upstream ports provide ways of compensating for noisy lines.

The customer personal computer and associated peripherals are termed Customer Premise Equipment (CPE). Customer premise equipment are connected to the cable modem, which is in turn connected through the HFC network to the cable modem termination system. The modular cable modem termination system routes traffic between the HFC and the Internet. Using the modular cable modem termination system, a cable operator can control the cable modem's configuration. Cable modem configuration may be changed to adjust for varying line conditions and customer service requirements.

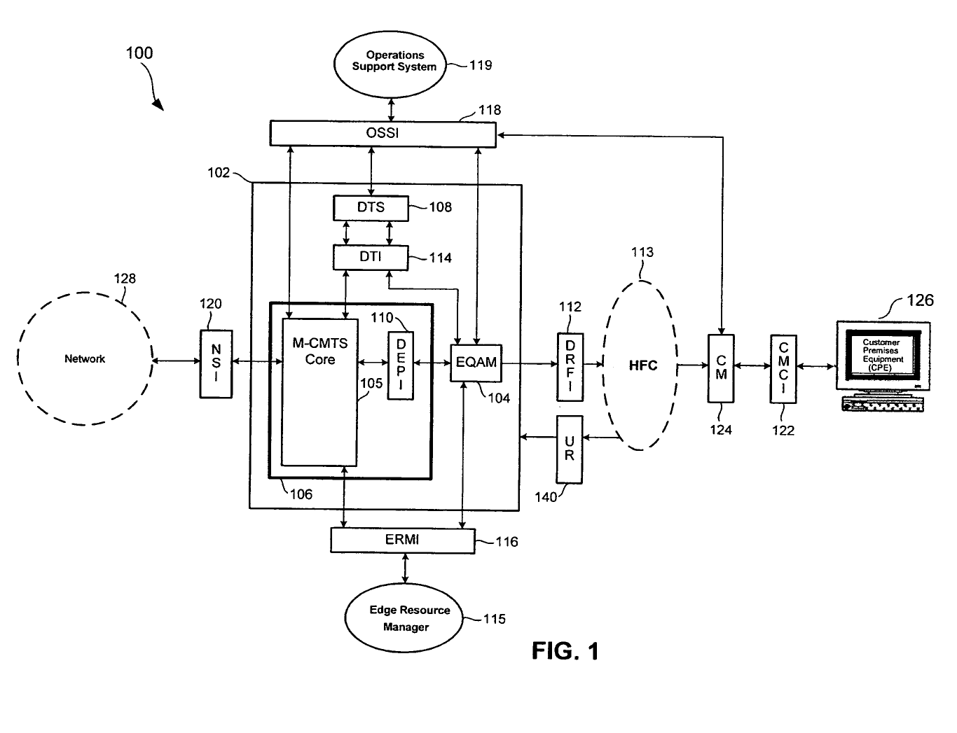

FIG. 1 illustrates an example DOCSIS communications system 100 according to an embodiment of the invention. System 100 includes network 128, Network Side Interface (NSI) 120, Modular Cable Modem Termination System (M-CMTS) 102, Edge Resource Manager (ERM) 115, Edge Resource Management Interface (ERMI) 116, Operations Support Systems Interface (OSSI) 118, Operations Support System (OSS) 119, Downstream Radiofrequency Interface (DRFI) 112, upstream receiver (UR) 140, Hybrid Fiber-Coaxial (HFC) Network 113, Cable Modem (CM) 124, Cable-modem to Customer Interface (CMCI) 122 and Customer Premises Equipment (CPE) 126.

Network 128 may be a wide area network or local area network. In an embodiment, network 128 is an Ethernet network. Network side interface 120 is the physical interface for M-CMTS 102 to connect to network 128.

M-CMTS 102 includes DEPI core 106, Edge Quadrature Amplitude Modulator (EQAM) 104, DOCSIS Timing Server (DTS) 108 and DOCSIS Timing Interface Server (DTI) 114.

DEPI Core 106 includes Downstream External PHY Interface (DEPI) 110 and Modular Cable Modem Termination System (M-CMTS) core 105. M-CMTS core 105 performs DOCSIS Media Access Control (MAC) functions. These functions include signaling, downstream bandwidth scheduling and DOCSIS framing. DEPI 110 is typically an internet protocol tunnel that exists between a DOCSIS MAC layer in M-CMTS core 105 and a DOCSIS PHY layer that exists in the edge quadrature amplitude modulator 104. Downstream external PHY interface 110 contains both a data path for DOCSIS frames and a control path for setting up, maintaining and terminating data transfer sessions. Downstream external PHY interface 110 transports formatted DOCSIS frames or MPEG packets according to a layer 2 or layer 3 protocol and delivers them to edge quadrature amplitude modulator 104 for transmission. The base protocol used by downstream external PHY interface 110 to format packets is the Layer 2 Tunneling Protocol Version 3 (L2TPv3). L2TPv3 is a generic protocol for creating a “pseudowire” which is a mechanism to transparently transport a layer 2 protocol over a layer 3 network. Protocols supported by L2TPv3 include but are not limited to Asynchronous Transfer Mode (ATM), High-level Data Link Control (HDLC), Ethernet, Frame Relay and Point-to-Point Protocol (PPP).

DOCSIS timing server 108 is a timing signal generator. DOCSIS timing server 108 provides a common frequency (e.g. 10.24 MHz) and a DOCSIS timestamp to other M-CMTS 102 modules. DOCSIS timing server 108 distributes a DOCSIS timestamp and the common frequency over unshielded twisted pair (UTP). DOCSIS timing interface 114 automatically compensates for cable length and ensures that all M-CMTS 102 elements are synchronized by time and frequency.

DOCSIS timing interface 114 is a point-to-point interface from DOCSIS timing server 108 to other M-CMTS 102 modules. Each DEPI core 106 (if there are multiple cores 106) and edge quadrature amplitude modulator 104 has an associated DOCSIS timing interface 114 module.

Edge quadrature amplitude modulator 104 is a head end or hub device that receives packets of digital video or data. It re-packets the video or data into an MPEG transport stream and digitally modulates the digital transport stream onto a downstream Radio Frequency (RF) carrier using quadrature amplitude modulation (QAM). Edge quadrature amplitude modulator 104 contains Physical Layer (PHY) related circuitry, such as QAM modulators, and tunneling logic to connect to DEPI core 106.

Edge resource manager interface 116 comprises three interfaces (not shown): a registration interface between edge quadrature amplitude modulator 104 and edge resource manager 115, an EQAM control interface between edge quadrature amplitude modulator 104 and edge resource manager 115 and a M-CMTS control interface between M-CMTS core 106 and edge resource manager 115. The registration interface is used to register and un-register edge quadrature amplitude modulator 104 resources (i.e., QAM channels) with edge resource manager 115. The EQAM control interface is used by edge resource manager 115 to request QAM channel resources from edge quadrature amplitude modulator 104. The EQAM control interface is also used by edge quadrature amplitude modulator 104 to deliver resources to edge resource manager 115. The M-CMTS control interface is used by M-CMTS core 106 to request specific QAM channel resources from edge resource manager 115 and by edge resource manager 115 to respond to requests with the location of QAM channel resources.

Operations support systems interface 118 provides a management interface to each system 100 component. Operations support systems interface 118 monitors M-CMTS 102 functions and may be used in place of edge resource manager interface 116 to statically configure and associate QAM channel resources with M-CMTS cores 106. Operations support systems interface 118 allows for the modification of a QAM channel's physical layer parameter by either M-CMTS core 106 or edge quadrature amplitude modulator 104.

Operations support system 119 monitors underlying networks in system 100. Operations support system 119 monitors functional and non-functional requirements of system 100 and handles errors.

Downstream radio frequency interface 112 captures current and future radio frequency requirements in the downstream direction for integrated DOCSIS CMTS systems, M-CMTS systems 106 and Video On Demand (VOD) edge quadrature amplitude modulator systems.

Upstream receiver 140 serves as an interface for upstream communications from cable modem 124 to cable modem termination system 102.

Hybrid Fiber-Coaxial Network 113 incorporates both optical fiber along with coaxial cable to create a broadband network. An optical node converts optical signals to electrical and vice versa.

Cable modem 124 is a modulator-demodulator at subscriber locations for conveying data communications on a cable television system.

Cable-modem to customer interface 122 is typically 10/100 Mbps Ethernet or USB.

Customer premise equipment 126 is equipment at the end user's premises. Customer premise equipment 126 is typically a personal computer.

### 3. DEPI CORE ARCHITECTURE

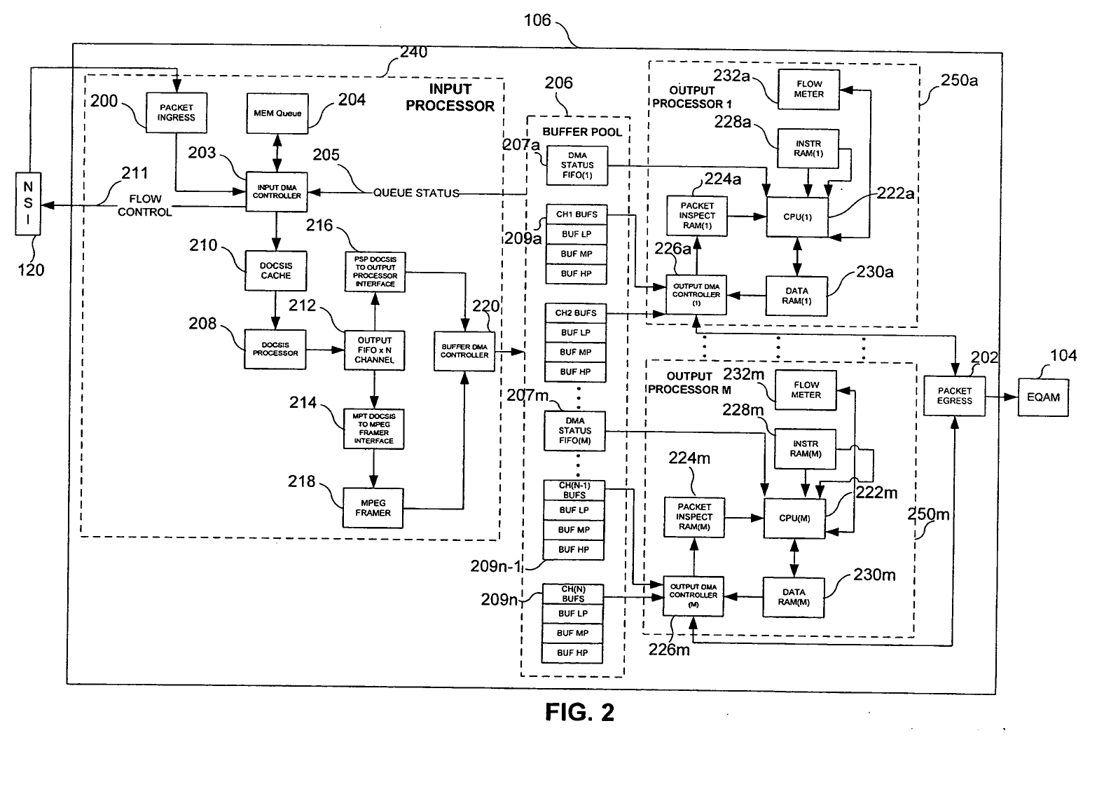

FIG. 2 illustrates DEPI core 106 according to an embodiment of the present invention. DEPI core 106 sends packets received from network system interface 120 to edge quadrature amplitude modulator 104 in a configurable output format and at edge quadrature amplitude modulator 104 line rate. The output format of the packets is configurable by programming output processors 250a-m. In an embodiment the output format for packets leaving core 106 is Layer 2 Tunneling Protocol Version 3 (L2TPV3) format. In an embodiment, core 106 is used for line rate Field Programmable Gate Array (FPGA) or Application Specific Integrated Circuit (ASIC) applications. It is to be appreciated that even though core 106 is described with reference to DOCSIS system 100, it may be applied to any communication protocol where packets from multiple channels and multiple priorities per channel are to be processed with a high bandwidth protocol engine followed by formatting into packets by a programmable header generator or protocol encapsulation engine.

Ethernet packets from network system interface 120 enter core 106 via packet ingress module 200. Modules within core 106 convert these packets into DOCSIS compatible packets which are then encapsulated into one of two different formats: Moving Picture Experts Group Transport Stream (MPT) or Packet Streaming Protocol (PSP). The encapsulated packets are then formatted according to the L2TPV3 protocol. The L2TPV3 formatted packets are sent to edge quadrature amplitude modulator 104 via packet egress module 202. Core 106 is enabled to support data bursting during ingress at a much higher bandwidth than packets are processed and leave during egress thereby avoiding stalls. In an embodiment, network 128 is Gigabit Ethernet and network system interface 120 is a Gigabit Ethernet interface. It is to be appreciated by persons of skill in the art that in alternate embodiments network 128 and network system interface 120 could be used with any type network including but not limited to a Wide Area Network (WAN), Local Area Network (LAN) and Metropolitan Area Network (MAN).

Core 106 supports N channels of data with Q levels of priority per channel. Conventional DEPI cores employ multiple input processors with a processor associated with each channel. Core 106 comprises a single input processor 240 for the N channels and Q priorities per channel. Core 106 also comprises a buffer pool 206 and M output processors 250a-m. In the present embodiment, the N data channels with Q levels of priority are processed with M output processors 250a-m where an output processor 250 is enabled to support more than one channel. In alternate embodiments, the number of processors M may be more than, less than or equal to the number of channels N. Furthermore, there may be none, one or more than one priority levels Q per channel. It is to be appreciated by persons of skill in the art that the number of priority levels per channel is arbitrary and may be scaled to any number of priority levels in alternate embodiments. Likewise, it is to be appreciated that the number of channels and protocol encapsulation engines is also arbitrary.

3a. Input Processor

In the illustrated embodiment, input processor 240 comprises packet ingress module 200, input DMA controller 203, DOCSIS cache 210, MEM queue 204, DOCSIS processor 208, PSP DOCSIS to output processor interface 216, output FIFO 212, MPT DOCSIS to MPEG processor interface 214, MPEG framer 218 and buffer pool DMA controller 220.

Data enters core 106 via packet ingress module 200 and is transferred by input DMA controller 203 to queues in MEM queue 204. MEM queue 204 is partitioned to store data corresponding to N channels with each channel having three levels of priority, Low Priority (LP), Medium Priority (MP) and High Priority (HP). MEM queue 204 is preferably a memory with capacity and bandwidth to support ingress at the maximum packet rate or at edge quadrature amplitude modulator line rate. MEM queue 204 may be Double Data Rate (DDR) Random Access Memory (RAM). In an embodiment, there are distinct queues in MEM queue 204 for each channel and priority level.

Input DMA controller 203 is responsible for arbitration between the N channels and the Q priorities per channel. It is to be appreciated by persons of skill in the art that any arbitration mechanism may be used. In an embodiment, priority arbitration is used where higher priority queues always empty before lower priority queues empty. In another embodiment, round robin priority arbitration is used where each channel is assigned an even number of slots to empty a queue. Input DMA controller 203 buffers packet header and packet data in the DOCSIS cache 210. Caching portions of header information required for ordering decisions in DOCSIS cache 210 enables ordering decisions to be made without using up bandwidth in MEM queue 204. In an embodiment DOCSIS cache 210 serves as a First In First Out (FIFO) Protocol Data Unit (PDU) queue. DOCSIS cache 210 provides a continuous stream of data to high bandwidth DOCSIS processor 208 thereby preventing DOCSIS processor 208 from idling.

Input DMA controller 203 asserts flow control signal 211 to indicate the status of the queues in MEM queue 204 to network side interface 120 which is the data source for core 106. Network side interface 120 stops sending data in on queues which are full in MEM queue 204. For example, if the medium priority buffer for the first channel is full then the network side interface 120 stops sending data for that priority level of the first channel. Input DMA controller 203 can be programmed to provide the status of queues in MEM queue 204 via the flow control signal 211 when the queues reach a predetermined percentage or fraction of the maximum queue depth. In an embodiment a hysteresis function is used to provide an indication via flow control signal 211 when the queue depth drops below a specific percentage or fraction of the queue depth for a particular channel and priority level. In the present embodiment, the data source to core 106 is network side interface 120, however, in an alternate embodiment the data source may be a processor or another interface (not shown).

DOCSIS processor 208 is enabled to process N channels of data, each channel having Q levels of priority. DOCSIS processor 208 is enabled to time division multiplex its processor bandwidth across each of the N channels and Q priority levels per channel. Data buffered in DOCSIS cache 210 provides a continuous stream of data for DOCSIS processor 208.

DOCSIS processor 208 performs DOCSIS operations on packets received from DOCSIS cache 210 including but not limited to Payload Header Suppression, Baseline Privacy and DOCSIS header creation. Tag information on incoming packets indicates what processing operations are to be performed. Payload Header Suppression operation causes fixed fields in the packet header to be replaced with smaller tags. Baseline Privacy operation causes a large portion of the packet to be encrypted with either Data Encryption Standard (DES) or Advanced Encryption Standard (AES). DOCIS header creation operation causes insertion of DOCSIS Extended Headers and creation of DOCSIS header elements. DOCSIS header creation function also causes creation of a header Cyclic Redundancy Check (CRC).

The output of the DOCSIS processor 208 is packets formatted according to DOCSIS protocol which are stored in output FIFO 212. Output FIFO 212 is configured to accommodate packets corresponding to N channels and Q priorities per channel. Buffering in output FIFO 212 is used to prevent stalls in core 106. Output FIFO 212 also serves as an interface mechanism for subsequent processing of DOCSIS packets.

DOCSIS packets stored in output FIFO 212 are formatted according to one of Moving Picture Experts Group Transport Stream (MPT) format or Packet Streaming Protocol (PSP) formats. Packets in a channel, based on channel provisioning, are either assigned for MPT mode or PSP mode processing. The processing mode dictates the path of packets belonging to a channel from output FIFO 212 to either the MPT DOCSIS to MPEG framer interface 214 or PSP DOCSIS to output processor interface 216. A channel is provisioned for either MPT or PSP processing and all data on that channel is routed by output FIFO 212 to MPT DOCSIS to MPEG framer interface 214 or PSP DOCSIS to output processor interface 216 for processing accordingly.

The PSP format requires encapsulation of DOCSIS formatted packets in the L2TPV3 protocol. PSP is a layer 4/5 protocol that allows concatenation of multiple small packets into a larger packet and fragmentation of a large packet, exceeding the programmed Maximum Transmission Unit (MTU) size, into smaller packets. PSP DOCSIS to output processor interface 216 interfaces with output buffer DMA module 220 which places PSP formatted packets in respective priority and channel queues in buffer pool 206. PSP packets buffered in buffer pool 206 are processed by output processors 250 and sent to edge quadrature amplitude modulator 104 over a controlled latency network. Edge quadrature amplitude modulator 104 formats the PSP packets in the MPEG2 Transmission Convergence Layer protocol. The MPEG-2 Transmission Convergence layer protocol encapsulates the PSP formatted packets into MPEG2 frames. This allows MPEG2 encapsulated PSP data to be multiplexed with other MPEG streams on the same carrier on the forward path. For example, MPEG2 video and audio may be sent on the same carrier as MPEG2 encapsulated PSP data.

As described above, packets formatted according to DOCSIS protocol by DOCSIS processor 208 may be formatted according to MPT format instead of PSP format prior to being sent from core 106 to edge quadrature amplitude modulator 104. Packet header information is used to determine whether to process according to PSP or MPT format. The MPT format is a collection of MPEG2 packets into a single frame that is encapsulated in an L2TPV3 header. The MPT DOCSIS to MPEG framer interface 214 formats the DOCSIS packets according to the MPEG2 Transmission Convergence Layer protocol and sends the formatted packets to the MPEG framer 218. Since MPEG2 packets are fixed in size the number of MPEG2 packets (L) that can be placed in a L2TPV3 frame, is chosen to not exceed the Maximum Transmission Unit (MTU) size. MPEG framer 218 collects L MPEG2 packets. Since the size of each MPEG2 packet and the number of MPEG2 packets L in an L2TPV3 frame is fixed, there is no overhead of fragmentation and concatenation of frames in MPT mode processing. MPEG framer 218 inserts period synchronization messages between L2TPV3 frames to reduce jitter. Buffer pool DMA controller 220 places the framed data into single priority queues in buffer pool 206. The MPEG2 formatted packets collected in buffer pool 206 represent a bit stream going to edge quadrature amplitude modulator 104 for a given channel.

3b. Buffer Pool

In the embodiment illustrated in FIG. 2, buffer pool 206 comprises memory partitioned into N buffers 209a-n associated with corresponding N data channels. Each buffer 209 is further partitioned into Q levels of priority. In the present embodiment, there are three levels of priority: high (HP), medium (MP) and low level (LP) priorities. Buffer pool 206 also comprises M DMA status FIFOs 207a-m associated with corresponding M output processors 250a-m. Buffer pool 206 includes control logic (not shown) which provides queue status signal 205 to input DMA controller 203.

Data processed by DOCSIS processor 208 is buffered initially in output FIFO 212 and after further processing in buffer pool 206. If a corresponding buffer in buffer pool 206 becomes full then DOCSIS processor 208 may have to be stalled in order to prevent data overflow in buffer pool 206. To avoid stalling DOCSIS processor 208, buffer status from buffer pool 206 is supplied to input DMA controller 202 via Queue Status control signal 205. In this way, no packets are processed for channel and priority queues have no space to accept the packets. The Queue Status control signal 205 is generated by control logic (not shown) in buffer pool 206 that monitors status of buffers for each channel and each priority level within a channel. The queue status control signal 205 indicates whether a buffer in buffer pool 206 has capacity to receive another packet.

Buffer pool 206 also includes M DMA status FIFOs 207a-m. Buffer pool DMA controller 220 stores status events generated by the M DMA status FIFOs 207a-m associated with corresponding M processors 222a-m. Output buffer DMA 220 signals status events to each of M processors 222a-m via the stored status events in the M DMA status FIFOs 207a-m. The status information indicates that a packet of a particular size is placed within a particular buffer 209 of buffer pool 206. Information regarding the packet sizes queued in buffer pool 206 is retrieved by processors 222 from corresponding DMA status FIFOs 207 and L2TPV3 headers are generated for the relevant PSP or MPT mode.

3c. Output Processors

Output processors 250a-m encapsulate PSP or MPT formatted packets in an L2TPV3 format. Output processors 250a-m may also concatenate or fragment packets as needed. Output processors 250a-m each comprise a processor 222, instruction RAM 228, data RAM 230, packet inspect RAM 224, output DMA controller 226 and flow meter 232.

Output processors 250a-m execute instructions using processors 222a-m. The instructions are stored in the M instruction RAM units 228a-m. In an embodiment, instructions are stored in instruction RAM 228 from an external source before initialization of core 106. In an alternate embodiment, instruction RAM 228 may be reprogrammed with instructions at any time during operation of core 106. Instruction RAM 228 is multi-ported and a single instance of instruction RAM 228 supports multiple functions.

M units of data RAM 230a-m are used as a scratch pad memory by associated processors 222a-m and to store header templates and other constants required during processing. Sections of data RAM 230 are updated with header contents by corresponding processors 222.

Output processors 250 typically do not inspect the protocol data unit (PDU) of a packet stream to generate L2TPV3 headers. However, for applications where decisions based on PDU data are required, packet inspect RAM modules 224 are used. To facilitate inspection of certain packets, output DMA module 226 may be programmed to place packets in packet inspect RAM 224. Packet inspect RAM 224 allows messages to be sent in-band to processor 222 to enable provisioning of header templates and other channel parameters. Processor 222 may inspect Type of Service (ToS) bits in the header of a packet and make priority decisions based on the ToS bits.

Flow meters 232a-m include programmable timers, counters and threshold comparators (not shown) to facilitate rate shaping operations. Rate shaping is based in part on channel provisioning information. Flow meters 232a-m are programmable so as to not exceed a maximum modulator rate of edge quadrature amplitude modulator 104. In an embodiment the maximum modulator rate is not exceeded by using a “leaky bucket algorithm”. In an embodiment, the “bucket” is a counter, a data structure or any other software construct for tracking ingress and egress of packets in and out of core 106. When the bucket is at full capacity, output processors 250 stop sending packets to edge quadrature amplitude modulator 104 or reduce the rate at which packets are sent. Since packets stop leaving core 106, buffer pool 206 may fill to capacity. Based on queue status signal 205 asserted by buffer pool 206, input DMA controller 202 may assert flow control signal 211 to stop NSI 120 from sending more data for channels and priorities that cannot be accommodated in buffers 209. Input DMA controller 202 stops loading packets into DOCSIS processor 208. As packets are gradually sent to edge quadrature amplitude modulator 104, the “bucket” empties and packet ingress module 200 again starts receiving packets from NSI 120. In an alternate embodiment, NSI 120 or a processor sourcing data to core 106 may control the flow of packets sent to core 106 based on queue status signal 205 and/or flow control signal 211.

Output DMA controllers 226a-m prefix output packets with the header contents stored in corresponding data RAMs 230a-m. Output DMA controllers 226 also append packet data to the output packet. In the case of concatenation, output DMA controllers 226 append multiple packets to an output packet. In the case of fragmentation, output DMA controllers 226 fragment a packet into multiple packets.

Packet egress module 202 interfaces output DMA controllers 226 to edge quadrature amplitude modulator 104. Packet egress module sends the Ethernet packets formatted according to PSP or MPT protocol and encapsulated in L2TPV3 layer to edge quadrature amplitude modulator 104.

### 4. EXAMPLE METHODS

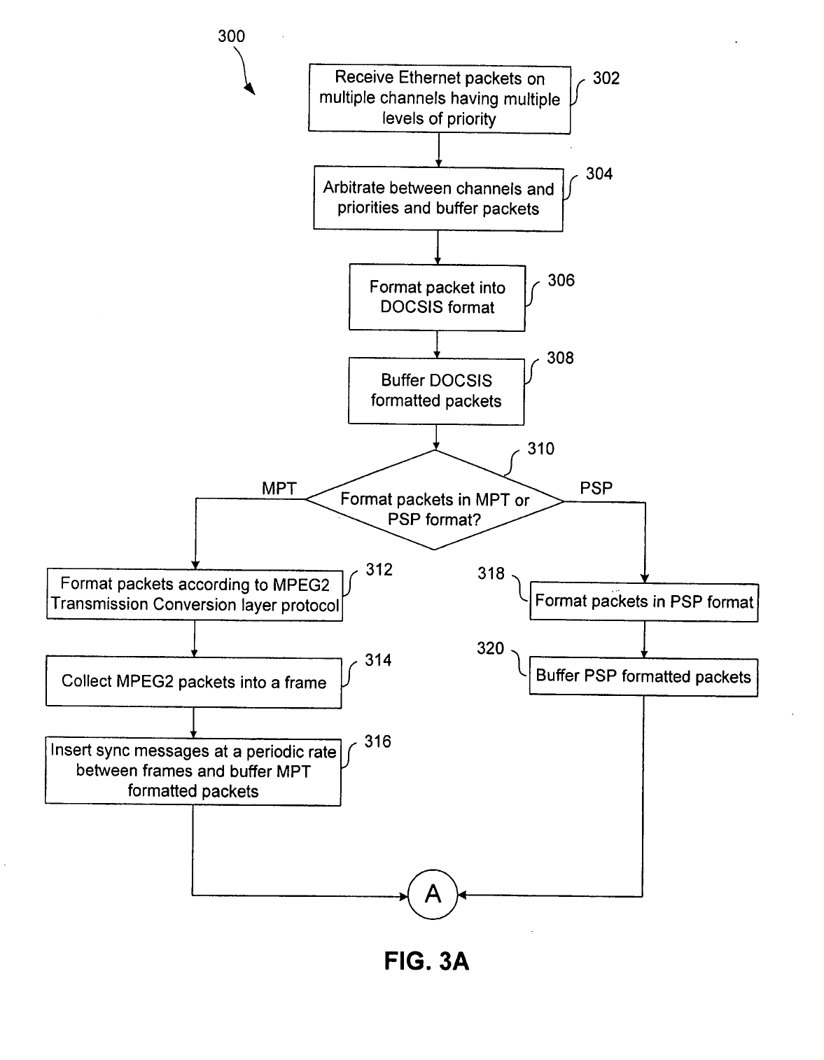

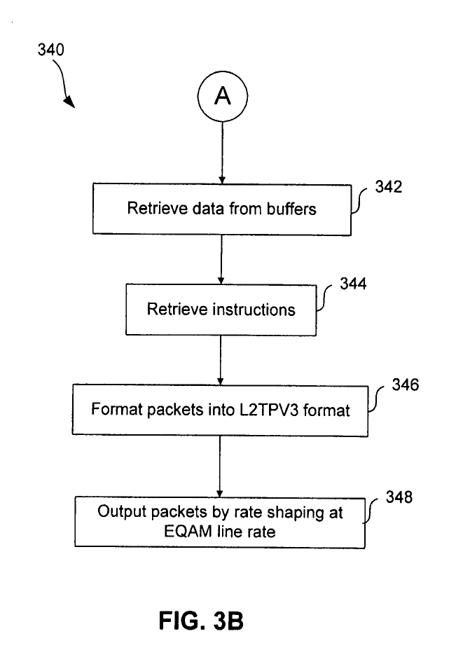

FIG. 3A illustrates a method for formatting Ethernet packets received on multiple data channels, each channel having multiple priorities levels in PSP or MPT format, according to an embodiment of the invention. Flowchart 300 will be described with continued reference to the example operating environment depicted in FIG. 2. In an embodiment, the steps illustrated in FIG. 3A are performed by input processor 240 illustrated in FIG. 2. However, the flowchart is not limited to that embodiment. Note that some steps shown in flowchart 300 do not necessarily have to occur in the order shown.

In step 302, Ethernet packets are received on multiple channels. Each channel may have multiple priority levels. For example, Ethernet packets from network side interface 120 may be received by packet ingress module 200.

In step 304, the multiple channels and multiple priorities per channel are arbitrated. Received packets are buffered according to channel and priority levels. For example, DMA control module 203 arbitrates between multiple channels and multiple priorities per channel by buffering packets in memory queue 204 according to channel and priority level. DMA control module 203 also caches packet headers and packet data in DOCSIS cache 210.

In step 306, packets from multiple channels are formatted into DOCSIS format by time division multiplexing across each of the channels and priority levels. Payload header suppression, baseline privacy and DOCSIS header creation functions may also be performed on the packets based on the packet header. For example, DOCSIS processor 208 may perform time division multiplex across the channels and priority levels to convert Ethernet packets into a DOCSIS format.

In step 308, packets formatted according to the DOCSIS protocol are buffered. For example, DOCSIS processor 208 may buffer the packets in output FIFO 212.

In step 310, it is determined whether the buffered DOCSIS packets are to be formatted according to the PSP or MPT format based on channel provisioning information.

In step 312, if it is determined in step 310 that the buffered DOCSIS packets are to be formatted according to MPT format, packets are formatted according to MPEG2 Transmission Convergence Protocol. For example, MPT DOCSIS to MPEG framer interface 214 formats the DOCSIS packets according to MPEG2 Transmission Convergence Protocol.

In step 314, a fixed number of MPEG2 packets (L) are placed into an L2TPV3 frame. For example by MPEG framer 218 places the fixed number of packets in the L2TPV3 frame.

In step 316, synchronization messages are inserted at a periodic rate between L2TPV3 frames. After the insertion of sync messages the packets are buffered. For example, MPEG framer 218 may insert the periodic sync messages and buffer pool DMA controller 220 may buffer the packets in buffer pool 206. Operation proceeds to the steps illustrated in flowchart 340 in FIG. 3B.

In step 318, if it is determined in step 310 that the DOCSIS packets are to be formatted in PSP format, the buffered DOCSIS packets buffered are formatted in PSP format. For example, PSP DOCSIS to output processor interface 216 formats the DOCSIS packets stored in output FIFO 212 into PSP format.

In step 320, the PSP formatted packets are buffered. For example, buffer pool DMA controller 220 buffers the PSP formatted packets in buffer pool 206. Operation proceeds to the steps illustrated in flowchart 340 in FIG. 3B.

FIG. 3B illustrates a method for formatting PSP or MPT formatted packets for multiple data channels, each channel having multiple priorities levels, in an L2TPV3 format and output the formatted packets at edge quadrature amplitude modulator line rate according to an embodiment of the invention. Flowchart 340 will be described with continued reference to the example operating environment depicted in FIG. 2. In an embodiment, the steps illustrated in FIG. 3B are performed by each of output processors 250a-m illustrated in FIG. 2. However, the flowchart is not limited to that embodiment. Note that some steps shown in flowchart 340 do not necessarily have to occur in the order shown.

In step 342, buffered PSP and MPT formatted packets are retrieved. For example, output processors 250a-m retrieve packets from buffer pool 206. Output DMA controller 226 may signal size and location of a packet in buffer pool 206 to output processors 250 via corresponding DMA status FIFOs 207.

In step 344, instructions for processing PSP or MPT packets are retrieved. For example, CPU 222 receives instructions from instruction RAM 228.

In step 346, retrieved PSP or MPT packets are formatted according to the L2TPV3 protocol. For example, CPU 222 updates sections of data RAM 230 with L2TPV3 header contents and output DMA controller 226 prefixes the PSP or MPT packets with the L2TPV3 header.

In step 348, the L2TPV3 formatted packets are output at edge quadrature amplitude modulator line rate. For example, packet egress module in conjunction with output DMA controller 226 outputs L2TPV3 formatted packet at edge quadrature amplitude line rate. Flow meter 232 may be used to rate shape the output rate so as to not exceed the edge quadrature amplitude line rate.

It is to be appreciated by persons of ordinary skill in the art that the present invention, or portions thereof, can be implemented in hardware, firmware, software, and/or combinations thereof.

### 5. EXAMPLE GENERAL PURPOSE COMPUTER SYSTEM

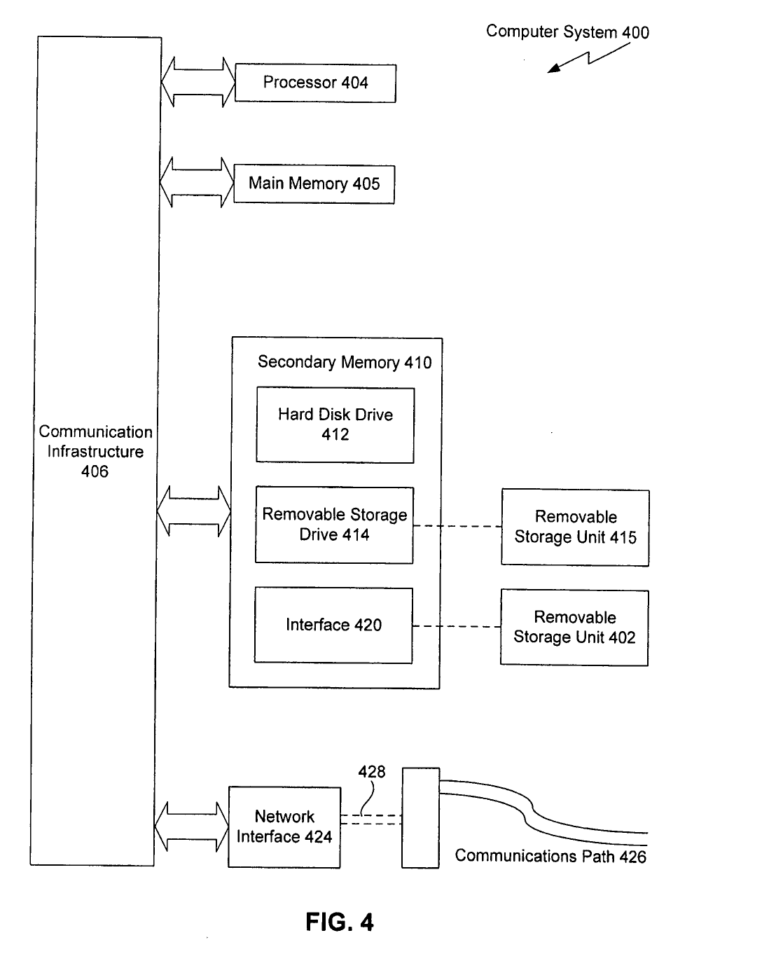

The following description of a general purpose computer system is provided for completeness. The present invention can be implemented in hardware, or as a combination of software and hardware. Consequently, the invention may be implemented in the environment of a computer system or other processing system. An example of such a computer system 400 is shown in FIG. 4. The computer system 400 includes one or more processors, such as processor 404. Processor 404 can be a special purpose or a general purpose digital signal processor. The processor 404 is connected to a communication infrastructure 406 (for example, a bus or network). Various software implementations are described in terms of this exemplary computer system. After reading this description, it will become apparent to a person skilled in the relevant art how to implement the invention using other computer systems and/or computer architectures.

Computer system 400 also includes a main memory 405, preferably random access memory (RAM), and may also include a secondary memory 410. The secondary memory 410 may include, for example, a hard disk drive 412, and/or a RAID array 416, and/or a removable storage drive 414, representing a floppy disk drive, a magnetic tape drive, an optical disk drive, etc. The removable storage drive 414 reads from and/or writes to a removable storage unit 418 in a well known manner. Removable storage unit 418, represents a floppy disk, magnetic tape, optical disk, etc. As will be appreciated, the removable storage unit 418 includes a computer usable storage medium having stored therein computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a PCMCIA slot and card, etc. Software and data transferred via communications interface 424 are in the form of signals 428 which may be electronic, electromagnetic, optical or other signals capable of being received by communications interface 424. These signals 428 are provided to communications interface 424 via a communications path 426. Communications path 426 carries signals 428 and may be implemented using wire or cable, fiber optics, a phone line, a cellular phone link, an RF link and other communications channels.

The terms “computer program medium” and “computer usable medium” are used herein to generally refer to media such as removable storage drive 414, a hard disk installed in hard disk drive 412, and signals 428. These computer program products are means for providing software to computer system 400.

Computer programs (also called computer control logic) are stored in main memory 408 and/or secondary memory 410. Computer programs may also be received via communications interface 424. Such computer programs, when executed, enable the computer system 400 to implement the present invention as discussed herein. In particular, the computer programs, when executed, enable the processor 404 to implement the processes of the present invention. Where the invention is implemented using software, the software may be stored in a computer program product and loaded into computer system 400 using raid array 416, removable storage drive 414, hard drive 412 or communications interface 424.

In other embodiments, features of the invention are implemented primarily in hardware using, for example, hardware components such as Application Specific Integrated Circuits (ASICs) and gate arrays. Implementation of a hardware state machine so as to perform the functions described herein will also be apparent to persons skilled in the relevant art(s).

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

### 6. CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system to format Ethernet packets corresponding to a plurality of channels, each channel having a plurality of priority levels, into Layer 2 Tunneling Protocol Version 3 (L2TPV3) format, comprising:
an input processor enabled to receive said Ethernet packets, format said Ethernet packets into a Data Over Cable Service Interface Specification (DOCSIS) format and convert said DOCSIS formatted packets into one of a Moving Picture Experts Group Transport Stream (MPT) format or a Packet Streaming Protocol (PSP) format;
a buffer pool coupled to said input processor and partitioned to store said MPT or PSP formatted packets according to respective channel and priority level; and
a plurality of output processors coupled to said buffer pool and enabled to format MPT or PSP formatted packets in the L2TPV3 format and output said L2TPV3 formatted packets at an edge quadrature amplifier modulator line rate.

2. The system of claim 1, wherein said input processor comprises a programmable input DMA controller enabled to arbitrate between said plurality of channels and plurality of priority levels per channel.

3. The system of claim 2, wherein said input DMA controller is enabled to cache said Ethernet packets in a memory queue.

4. The system of claim 3, wherein said input DMA controller is enabled to assert a signal, using a hysteresis algorithm, to indicate remaining capacity of said memory queue.

5. The system of claim 2, wherein said buffer pool comprises control logic that is enabled to transmit a signal to said input DMA controller to indicate remaining capacity of buffers in said buffer pool.

6. The system of claim 2, wherein said input processor further comprises a DOCSIS cache coupled to said input DMA controller and configured to cache packet headers and packet data of said Ethernet packets.

7. The system of claim 1, wherein said input processor further comprises a DOCSIS processor enabled to time division multiplex processing bandwidth across said Ethernet packets corresponding to the plurality of channels and priority levels and convert the Ethernet packets into the DOCSIS format.

8. The system of claim 7, wherein said DOCSIS processor is enabled to generate DOCSIS headers for said Ethernet packets.

9. The system of claim 7, wherein said DOCSIS processor is enabled to replace a first tag in an Ethernet packet header with a second tag that is smaller in size than said first tag.

10. The system of claim 7, wherein said DOCSIS processor is enabled to encrypt a portion of at least one of said Ethernet packets in one of a Data Encryption Standard (DES) or an Advanced Encryption Standard (AES).

11. The system of claim 1, wherein said input processor further comprises a PSP processor enabled to convert said DOCSIS formatted packets into PSP format.

12. The system of claim 1, wherein said input processor further comprises a MPEG processor enabled to convert said DOCSIS formatted packets into Motion Picture Experts Group 2 (MPEG2) packets.

13. The system of claim 12, wherein said input processor further comprises a MPEG framer enabled to aggregate a plurality of said MPEG2 packets into a frame.

14. The system of claim 13, wherein said MPEG framer is enabled to insert periodic synchronization messages between a plurality of frames.

15. The system of claim 1, wherein each of said output processors further comprises:
an instruction memory configured to store instructions;
a data memory; and
a central processing unit (CPU) enabled to execute instructions stored in said instruction memory; wherein said central processing unit is enabled to generate L2TPV3 headers for MPT or PSP formatted packets and store the L2TPV3 headers in the data memory.

16. The system of claim 1, wherein each of said output processors further comprises an output DMA controller enabled to prefix MPT or PSP formatted packets with an L2TPV3 header.

17. The system of claim 16, wherein each of said output processors further comprises a flow meter enabled to control egress of said packets with L2TPV3 headers at an edge quadrature amplitude modulator line rate.

18. The system of claim 1, further comprising a packet egress module enabled to transmit said L2TPV3 formatted packets to an edge quadrature amplitude modulator.

19. An interface between a network and an edge quadrature amplitude modulator (EQAM), comprising:
an input direct memory access (DMA) controller enabled to control a rate at which packets are received from the network;
a plurality of buffers configured to buffer said packets;
a first module enabled to convert buffered packets to a first format;
a second module enabled to convert packets formatted in said first format to a second format;
an instruction memory enabled to store instructions;
a plurality of processors enabled to customize an output format of packets formatted in said second format based on said instructions in said instruction memory;
a plurality of flow meters enabled to determine an output rate for packets in said second format based on, at least in part, a modulator rate of the (EQAM); and
an output DMA controller enabled to control the rate at which packets in said second format are sent to the EQAM.

20. The interface of claim 19, wherein the output DMA controller is enabled to concatenate multiple packets in said second format or fragment a packet in said second format into multiple packets.

21. The interface of claim 19, wherein the first format is one of a Moving Picture Experts Group Transport Stream (MPT) or a Packet Streaming Protocol (PSP) format and the second format is Layer 2 Tunneling Protocol Version 3 (L2TPv3) format.

22. A method to interface a network to an edge quadrature amplitude modulator (EQAM), comprising:
receiving packets from the network;
formatting the received packets into a first format;
buffering the packets formatted in the first format;
formatting the buffered packets in a second format; and
transmitting the packets formatted in the second format to the EQAM at a rate based on a modulator rate of the EQAM.

23. The method of claim 22, wherein the first format is one of a Moving Picture Experts Group Transport Stream (MPT) format or a Packet Streaming Protocol (PSP) format and the second format is a Layer 2 Tunneling Protocol Version 3 (L2TPv3) format.

24. The method of claim 22, further comprising controlling the flow of packets received from the network based on remaining capacity of a buffer pool and a rate of egress of packets in the second format.
